(19) United States
(12) Patent Application Publication
(10) Pub. No.: US 2003/0018701 A1
(43) Pub. Date: Jan. 23, 2003

(54) Peer to peer collaboration for supply chain execution and management

(76) Inventors: Gregory Kaestle, Woodland Hills, CA (US); Eddie Shek, Sherman Oaks, CA (US)

Correspondence Address: Marc E. Brown, MCDERMOTT, WILL & EMERY, Suite 3400, 2049 Century Park East, Los Angeles, CA, 90067, US

(21) Appl. No.: 10/137,549

(22) Filed: May 2, 2002

Related U.S. Application Data
(60) Provisional application No. 60/288,753, filed on May 4, 2001.

(51) Int. Cl. G06F 15/16

(52) U.S. Cl. 709/201

(57) ABSTRACT

A peer to peer collaboration communications network architecture is disclosed wherein a plurality of enterprises effectively communicate with one another to share data across a single network. The network architecture simplifies management by partitioning supply chain network enterprises into groups that are independently managed. The network architecture allows for high speed transactions by minimizing distributions of queries upon multiple enterprise networks. At the same time, the network architecture allows for security and privacy concerns of individual enterprises to be addressed within small, localized portions of the overall network architecture. Users of the architecture therefore have the flexibility of choosing between overall speed and localized security modeling. The network architecture comprises a plurality of sub networks that are communicative with one another. Security and privacy concerns are modeled into the sub networks, while the overall architecture takes its shape and robust scalability from the interconnections of the plurality of sub networks.

### RELATED APPLICATIONS

This Application claims priority to U.S. Provisional Application No. 60/288,753, filed May 4, 2001, the contents of which are incorporated herein by reference.

### BACKGROUND OF THE INVENTION

1. Field of the Invention

This invention relates to supply chain networks and structures for their management. More particularly, the invention relates to computerized network structures for optimizing the efficiency of supply chain interaction and management.

2. General Background and State of the Art

Supply chain management (SCM) involves managing the bi-directional flow of goods, services and information, from suppliers of suppliers, to suppliers, to manufacturers, to wholesalers, to distributors, to stores, to consumers and to end-users. The complexity and the cost of supply chains have significantly and continuously increased during the past two decades. One result of this growth is that performance has been difficult to maintain and optimize. Companies have realized that, in many cases, their customers' satisfaction is linked to the performance of their supply chain. Therefore, performance is a very important feature of SCM, and one for which new solutions for optimization, efficiency and reliability would provide significant advances in the art.

Unfortunately, while improving performance of supply chain networks may initially seem to be a single, easily achievable goal, SCM is quite a complex process. SCM is the combination of art and science that addresses the goal of improving the way a company finds the raw components it needs to make a product or service, manufactures that product or service and delivers it to customers. There are five basic components of typical SCM architectures.

The first component of SCM is a plan. This is the strategic portion of SCM, directed to a strategy for managing the numerous resources that are required for meeting customer demand for a product or service. An integral part of planning involves developing a set of metrics to monitor the supply chain so that it is efficient, costs less and delivers high quality and value to customers.

The second component is referred to as a source. The source component involves selecting the suppliers who will deliver the goods and services necessary for creating the product or service. This includes developing a set of pricing, delivery and payment processes with suppliers and creating metrics for monitoring and improving the relationships. It further involves developing processes for managing the inventory of goods and services received from suppliers, including receiving shipments, verifying them, transferring them to manufacturing facilities and authorizing supplier payments.

Third is the make component, which is the manufacturing step of SCM. The make component involves scheduling the activities necessary for production, testing, packaging and making preparations for delivery. This component also includes the most metric-intensive portion of the supply chain, involving measuring quality levels, production output and worker productivity.

The fourth component is the deliver or “logistics” component of SCM. This component involves coordinating the receipt of orders from customers, developing a network of warehouses, selecting carriers to get products to customers and establishing an invoicing system to receive payments.

Finally, SCM includes a return component for handling problems that are produced through the supply chain. Specifically, the return component involves creating a network for receiving defective and excess products back from customers and supporting customers who have problems with delivered products.

It is apparent from the brief introduction to the five typical SCM components that SCM can quickly become very complicated. As a result, an efficiency-driven solution for supply chain networks can be very difficult to achieve. This is because such solutions must address the various requirements and goals of each of the five basic components of SCM that are discussed above. Also, with the advent of enterprise application integration (EAI) technologies, which allow for communication between different systems having different networks, message formats and protocols, SCM would benefit from being able to utilize such cross-platform capability. However, this is another complicating factor that has made efficient supply chain network solutions difficult to design and implement. Several architectures designed to achieve such solutions have been utilized in supply chain networks, but they are undesirable for several reasons. Although EAI technology has allowed the creation of single application solutions, capable of combining all of an enterprise's data and processes into one logical unit so that intelligent SCM is supported, the single application solutions have been only partial solutions to date. These prior art architectures and their various drawbacks are described below.

A first type of architecture that has taken advantage of EAI technology is a simple “hub-spoke” model. Using this approach, data from multiple heterogeneous systems is converted to a common format using conventional EAI methods. The converted data is then sent in messages to a single hub system, which aggregates the data. The hub system also serves as a platform upon which applications can be built.

According to this design, an enterprise having multiple legacy systems can aggregate data from each of the legacy systems at a central location, upon which applications can be built to easily interface with all of the enterprise's various legacy systems and data. This is valuable, for example, to an enterprise such as a materials supplier who has multiple legacy systems designed to handle pricing, ordering, shipping, accounts receivable, and the like. Each legacy system has a unique data format, yet the materials supplier enterprise may wish to have applications that utilize the data from each of these systems.

FIG. 1 illustrates a typical hub spoke system. A single enterprise 100 includes a first legacy system 102 and a second legacy system 104, each having its own data format. An EAI adapter 106, which is a well known tool in the art, is used to map data from first legacy system 102 to a standard data format 108. A second EAI adapter 110 maps data from second legacy system 104 to standard data format 108. The data, in standard data format 108, is stored at central hub 112. Central hub 112, in addition to aggregating data from the multiple legacy systems, serves as a platform upon which applications can be built for enterprise 100.

The hub spoke system has multiple benefits. First, it is very useful for ASP applications. Also, because of the ease of hosting a single hub, it is convenient for solution providers to host a hub and provide solutions to its clients (enterprises). However, there are also a number of problems associated with hub spoke model solutions. For example, the hub spoke model is not ideal for systems requiring collaboration among separate enterprises that wish to share data. Due to data sensitivity and security issues, some enterprises may be reluctant to publish their data to a shared data store (hub) for the mere benefit of sharing a small portion of the data for collaboration. Also, such a networked system may be geographically disadvantage. This is because often times, enterprises engage in the practice of partitioning units of data into collections of servers where the owners of the data can conveniently diagnose problems onsite. Were the enterprises required to store their data at a remote hub, such as a server overseas or otherwise geographically distant, problems with their own data would not be easily addressed.

A second type of architecture that has taken advantage of EAI technology and avoids some of the problems of the hub spoke model described above is a “distributed agent” model. This approach involves a completely decoupled network, in which data is not stored at a single location only. Rather, data is stored at a plurality of separate locations. In this model, EAI adapters provide a consistent application program interface (API) to the underlying system and its legacy systems, in contrast to the hub-spoke model which, as described above, requires legacy systems to forward their information in a standardized message format. In the distributed agent model, a single query cannot be run against the totality of data because of the distributed storage design of this model. Therefore, when a query is to be run against all data in the underlying system, agents are “sent” to each of the systems in question, and they collect answers from the distributed sources. The agents then return these answers to the source of the query, where the answers are aggregated and the query result is presented.

FIG. 2 illustrates a typical distributed agent model. According to this model, a presentation system 200 resides at a central hub and is communicative with a first enterprise 202 and a second enterprise 204. When a query is generated at presentation system 200, agents 206 and 208 are sent, with information about the query 210 and 212, respectively, to the legacy system 214 of the first enterprise 202 and the legacy system 216 of the second enterprise 204, respectively. An answer is generated by legacy system 214, and converted to a standard format by first EAI adapter 218 upon receipt of the query by agent 206. Answer 220, in standard format, is then delivered to presentation system 200. Similarly, agent 208 carries the query to legacy system 216 of the second enterprise 204, an answer is generated, converted to standard format by an EAI adapter 222, and the converted answer 224 is delivered to presentation system 200.

Distributed agent models, as described above, clearly address the security and privacy problems of data from multiple enterprises that were not addressed by the hub spoke models. Unfortunately, however, distributed agent models are not readily scalable because of their complex nature. For queries involving multiple levels of legacy systems, and multiple agent deployments, distributed agent models are simply too cumbersome. They typically require more bandwidth than is practical, and significantly inhibit the performance of a system. Therefore, distributed agent models are not practical.

What is needed is an architecture for communication between multiple enterprises having unique native legacy systems, the architecture providing both a level of security that is sufficient for the privacy and security concerns of participating enterprises, and a level of performance that causes the architecture to be efficient and practical.

### INVENTION SUMMARY

The present invention involves a “peer to peer” architecture model for providing communication between multiple enterprises. Although each of the enterprises has its own unique legacy systems and data formats, and each of the enterprises has its own security and privacy concerns with respect to its data, the peer to peer model of the present invention is both efficient in handling multiple data formats and secure with respect to guarding privacy of multiple data sources and caches.

More specifically, the present invention provides a network communication between legacy systems of various enterprises. The peer to peer model utilizes metadata caching and models enterprises across a series of private networks. Within a single private network is one or more metadata aggregation nodes. These nodes operate to cache the entire data from remote networks for enterprises modeled on those networks, or metadata which instructs applications to directly contact the remote networks for data.

One goal of the peer to peer model of the present invention is to allow for data to be accessed locally through metadata caches, or remotely through direct access data. This availability of a selection between access options allows for optimization of performance of the overall system. It also provides a previously unrealized balance between retention of localized and controlled security of data within each enterprise, and potential for the overall system platform to remain robust and scalable as trust increases between the enterprise.

Another advantage of the peer to peer model of the present invention is that it allows for enterprises to model other enterprises as remote entities for security concerns, yet treat them locally when communicating, for efficiency and bandwidth concerns. Also, the present invention allows for the migration of data from one data format to another, for ease of communication between multiple enterprises. Yet another advantage of the present invention is that it provides universal referencing and data transformation for all networked communications.

The foregoing and other objects, features, and advantages of the present invention will be become apparent from a reading of the following detailed description of exemplary embodiments thereof, which illustrate the features and advantages of the invention in conjunction with references to the accompanying drawing Figures.

### BRIEF DESCRIPTION OF THE DRAWINGS

FIG. 1 illustrates a prior art “hub and spoke” communication model.

FIG. 2 illustrates a prior art “distributed agent” communication model.

FIG. 3 illustrates an exemplary sub network according to the present invention.

FIG. 4 illustrates an exemplary communications architecture model according to one embodiment of the invention.

FIG. 5 illustrates an exemplary sub network having a secondary enterprise modeled therein.

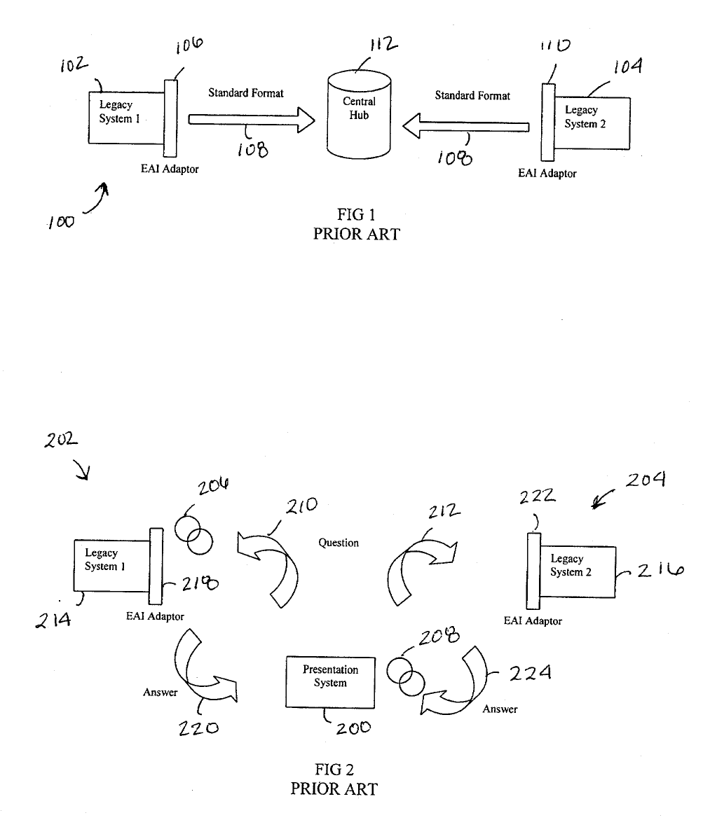

### DETAILED DESCRIPTION OF THE PREFERRED EMBODIMENTS

In the following description of the preferred embodiments reference is made to the accompanying drawings which form a part thereof, and in which are shown by way of illustration specific embodiments in which the invention may be practiced. It is to be understood that other embodiments may be utilized and structural and functional changes may be made without departing from the scope of the present invention.

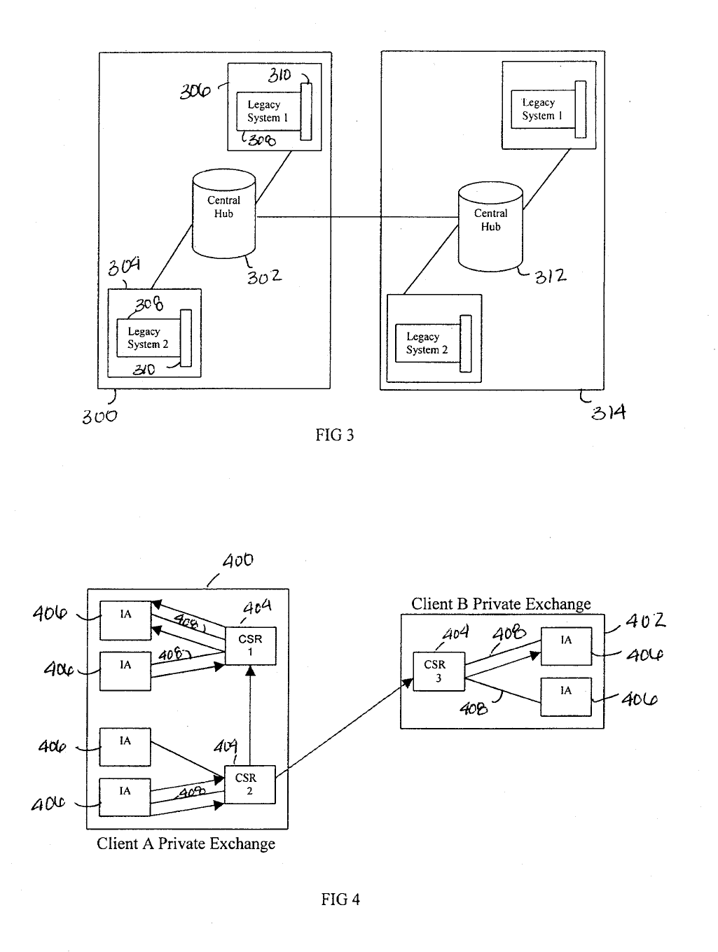

According to one embodiment of the present invention, an enterprise has communications capability via a local communications network. Local communications networks, as used herein, will be referred to as “sub networks” FIG. 3 illustrates an exemplary sub network. A sub network, shown generally at 300, provides communications capability between a central hub 302 and a plurality of nodes 304 and 306, each node comprising a legacy data processing system 308 and an integration adapter 310. Legacy data processing systems 308 are those systems used by an enterprise in the operation of its business. Any one enterprise may operate one or more legacy systems 308, and the data of each legacy system may have a unique, native data format. The integration adapter 310 operatively connected to each legacy system 308 performs the function of mapping the data of the legacy system to a common data format prior to the data being aggregated within the central hub 302. In addition to storing aggregated data, the central hub 302 serves as a platform upon which software applications are built. The software applications are communicative with the legacy systems within the sub network (“local sub network”) as well as with hubs 312 of other sub networks (“remote sub networks”) 314.

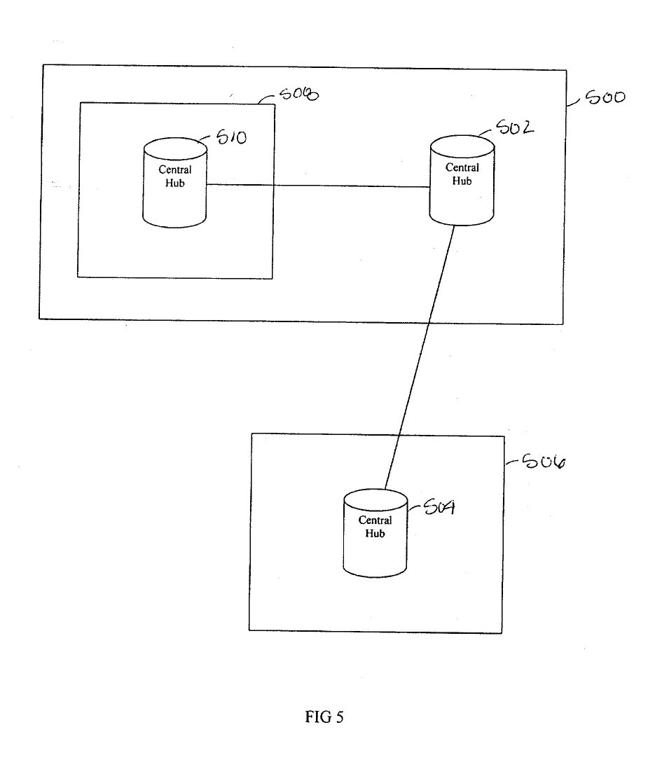

The present invention utilizes peer to peer communications in that it allows communication between nodes of separate sub networks. Therefore, it is important to understand the architecture scheme and communications rules of a peer to peer communications model according to the present invention. FIG. 4 illustrates exemplary communications rules. The peer to peer communications architecture comprises a collection of sub networks 400 and 402 that are operatively connected via collaborative synchronization routers (CSR) 404 and integration adapters 406. Communications connections 408 illustrate these operative connections.

A sub network may comprise one or more integration adapters 406, and may also comprise one or more CSRs 404. Each sub network 400 is denoted with a unique name. The naming convention may include, for example, the Internet domain or sub-domain of the overall purchaser and operator of the sub network, such as the domain of the enterprise. Using Internet domain names ensures that each sub network 400 within the overall peer to peer communications architecture has a unique name.

Within each sub network, each CSR and integration adapter must also be assigned a unique name. The name should uniquely identify the associated legacy data processing system on the sub network. However, a CSR or integration adapter on one sub network may have the same name as a CSR or integration adapter on a second sub network, even though both sub networks belong to the larger, overall peer to peer communications architecture.

Regarding the management of the naming conventions described above, within each sub network, all named entities share a single naming and directory service, implemented via a distributed directory service such as, for example, Lightweight Directory Access Protocol (LDAP). This naming service is capable of providing lookup and transport information for all nodes within the sub network, and is accessible to all nodes within the sub network. This means that any node can effectively and directly send a message to any other node within that sub network. Although the architecture does allow this capability, in operation this may not actually occur, as described below.

Although nodes within a sub network are capable, according to the peer to peer communications architecture of the present invention, of communicating directly with one another, messages are actually addressed to enterprises rather than to nodes. By addressing messages to entities, any hub receiving a message has enough information within the message to determine whether the message is, in fact, intended for a node within that (native) sub network, or if it is intended for a node in a remote sub network. This allows cross-communications between nodes within one sub network or across different sub networks. Business logic residing in CSR 404 makes this determinations, and also determines which legacy data processing system a message should be sent to when addressed to an enterprise.

Data messages may be sent for a number of different purposes. They may be sent to deliver data, such as for aggregation to a hub, or they may be sent to conduct a query. For example, a software application residing on a hub within a sub network may require data from a local or remote legacy data processing system, and may therefore send a query to retrieve that data. It will be recognized by those skilled in the art that data messages may represent a plurality of types of transactions that are sent on behalf of enterprises from associated legacy data processing systems. Each enterprise may have one or more legacy data processing systems associated with it to send messages to. Each legacy data processing system may also be associated with and broker messages for one or more enterprises. It should be noted that legacy data processing systems do not necessarily require a one-to-one correlation to an enterprise, and vice versa. That is, according to the teachings of the present invention, more than one enterprise may utilize the same legacy data processing system, and any one enterprise may utilize multiple legacy data processing systems. The business logic residing in CSRs 404 includes data regarding which enterprises are associated with which legacy data processing systems, and on which sub networks any of the above are members of. This data assists in the determination of where data messages are to be routed.

As discussed above, within each sub network, every enterprise must have a unique name. However, any one enterprise has the ability, according to the teachings of the present invention, to model secondary enterprises within their sub network. For example, as illustrated in FIG. 5, a first enterprise 500 is communicative via its hub 502 with the hub 504 of a second enterprise 506. First enterprise 500, however, may also contain within it a second enterprise 508, which is also modeled as a sub network around its hub 510. The sub network that includes hub 510, however, is communicative only with its top level sub network hub 502, which in turn is communicative with other “same-level” sub networks, such as sub network 506. The sub network of enterprise 500 and the sub network of enterprise 506 share the same CSR. In this way, the sub network including hub 510 is able to keep its data relatively private, such that it is only shared with sub network 500. Only pertinent data, then, as determined by business logic within hub 502 of sub network 500, would ever be shared or communicated with remote sub networks, such as sub network 506. It is important to note that such private sub networks (those within another sub network) must also have a unique name within the enterprise naming scheme for that CSR.

Regarding the business logic of a CSR, each enterprise has a “remote” flag associated with it. According to the value of this flag, the CSR of any one enterprise can determine whether or not received messages were sent from within the sub network of that enterprise or from within a remote sub network of a “foreign” enterprise. Of course, a remote sub network could also belong to the same enterprise because, as described earlier, any enterprise may be modeled to include more than one sub network.

Another security feature of the peer to peer communications architecture of the present invention involves the cross-modeling capabilities between enterprises. Specifically, enterprises within the same sub network should be completely cross modeled, meaning that every naming server within a sub network should include every enterprise within that sub-network. If, for some reason, one enterprise has particularly sensitive data that access should be limited to, that enterprise could be modeled within another, trusted enterprise as discussed above, or it could be included only on certain, trusted naming servers within the sub network. This flexibility in design of the naming servers allows for optimum communications capabilities, in that the communications network is minimally impinged by security concerns of certain enterprises. These security concerns, should they exist, can be modeled locally within small sections of the overall peer to peer communications architecture, so as to minimize detrimental effects on performance of the overall system.

Continuing with a description of the business logic within a CSR leads to a description of an exemplary message routing algorithm according to the teachings of the present invention. First, each sub network includes a multicast group for message routing. The multicast group for each sub network is capable of resolving which CSR (that is, from which sub network) handles requests for any particular enterprise. For example, in the case of a an enterprise within a single sub network, messages will always be resolved by the same CSR (the CSR belonging to that sub network). However, in the case of an enterprise that belongs to multiple sub networks, messages may be intended to be resolved by any one of a number of CSRs, depending on which sub network the node that message is intended for belongs to. Therefore, in the case of more than one sub networks within the overall peer to peer communications network, one sub network must assume ownership of each multicast group. If that rule is violated, then a requestor may end up with no sub network to which a data message can be sent.

In accordance with the exemplary message routing rules of the present invention, any sub network that sends a data message must do so on behalf of an enterprise. The data message may, of course, be sent to an enterprise on the same sub network or to an enterprise on a remote sub network. When a node of a sub network generates and sends a data message, the data message is first sent to the hub of that sub network. The CSR within the hub receives the data message and performs a series of steps using its business logic to determine how to route the data message. First, the CSR identifies the sender/receiver pair. That is, according to the naming conventions discussed above, the CSR can identify who sent the data message and who the intended recipient is. The recipient enterprise is identified according to the naming scheme discussed above. If the recipient enterprise is modeled as a local enterprise, the business logic of the CSR will name the legacy data processing system within its own sub network that the data message is to be sent to. Local legacy data processing systems, of course, are also modeled in that sub network's name server, because they are associated with the local enterprise.

If, on the other hand, the recipient enterprise is modeled as a remote enterprise, the sub network domain of that remote enterprise is examined by the local CSR business logic that is routing the data message. This domain might be the same domain as the sender of the data message, or it could be a different domain, indicating a remote sub network. If the domain name is the same as the sender enterprise's domain name, the business logic of the local CSR decides that the data message is a communication within the local sub network. The multicast group is then queried for the local exchange, and the data message is forwarded to the CSR (residing on the hub of an enterprise within the local sub network) that claims responsibility for that enterprise. Business logic on this CSR will dictate which legacy data processing system the data message is to be forwarded to. If the domain name indicates a remote sub network, however, the data message is forwarded to that sub network, where the steps are the same as those described above, except that the multicast group on the remote sub network is queried to begin the process.

The above description is an exemplary process for identifying the sender and recipient of a data message, and routing the message accordingly. Data messages may be in XML format or any other standard format that is compatible with the hubs and networking interfaces of the peer to peer communications architecture. Of course, regardless of the data message format, there remains a requirement for data translations between enterprises across sub networks or within a single sub network. Therefore, as part of the peer to peer communications network of the present invention, enterprises must provide data dictionaries through a lookup server whenever they are modeled as remote enterprises in order to facilitate this across-enterprises communication.

There may be circumstances, of course, in which a user of the system wishes to query data against a collection of enterprises. While the enterprises may reside solely within a single sub network, it is likely that they may also reside within a plurality of separate sub networks. The peer to peer communication architecture of the present invention includes a data access procedure to handle such situations. All data access occurs through methods on a data access objects (DAO) resident at CSR (hub) nodes within each sub network. These methods can be performed locally, and they can also be performed remotely with the use of enterprise java beans (EJB) or XML, using Simple Object Access Protocol (SOAP) or other scheme involving standard remote access methods. Whenever a DAO is called, the caller must identify itself as a user or enterprise. Each DAO, before gathering data, should check whether the calling enterprise is remote or local. If the enterprise is local, all data access should be through the database local to that CSR node. That data base may be resident, for example, on the hub of the local sub network. If the enterprise is remote, it should be referenced through the lookup scheme described above, involving considerations of domain names and message routing procedures. In either case, the method call is then made to the DAO on the local or remote CSR, and the data is returned via the network.

Of course, it will be apparent to those skilled in the art after learning the teachings of the present invention that the peer to peer communications architecture of the present invention provides a number of advantages not available in other network architectures. First, it allows a purchaser of the software, such as an enterprise, to aggregate all of their data sources into one network for fast searching. The modeling may include a single sub network or multiple, networked sub networks. This flexibility is available for the benefit of enterprises that have geographic or security concerns. Also, the same model can be applied to different enterprises, which allows multiple enterprises to communicate across different sub networks. This makes collaboration with external enterprises efficient and readily possible. The present invention also provides a flexible architecture in which security between collaborating enterprises is easy to manage, since enterprises simply refrain from modeling other enterprises whom they do not want to communicate with. This way, two enterprises who are unable to share data with each other can still belong to the same overall peer to peer communications network. Yet another advantage provided by the present invention is that each sub network represents a cache of data so that queries to aggregated data are fast. Within the architecture of the present invention, a user has the flexibility to choose between this speed and alternative messaging options that are available to increase security.

The foregoing description of the preferred embodiments of the invention has been presented for the purposes of illustration and description. It is not intended to be exhaustive or to limit the invention to the precise form disclosed. Many modifications and variations are possible in light of the above teaching. For example, legacy data processing systems are not limited to being software applications as described herein. Rather, they may be files, file servers, spreadsheets, or other data tracking and processing means utilized by an enterprise for conducting its business. Among other possibilities, the invention may be utilized to create supply chain management systems across a large number of involved enterprises, or across a subset of those enterprises involved in the supply chain. It is intended that the scope of the invention be limited not by this detailed description, but rather by the claims appended hereto.

What is claimed is:

1. A system for managing supply chain information comprising:
(a) a plurality of sub networks, each one of which comprises:
(i) a hub for containing common information;
(ii) a plurality of data processing systems for issuing data messages to the hub;
(b) a communication system for communicating between the hubs of the plurality of sub networks; and
(c) a logic system in communication with each of the hubs for determining whether a data message from one of the plurality of data processing systems can be satisfied wholly within the sub network of which the one of the plurality of data processing systems is a member, or whether it must be satisfied within a remote sub network.

2. A system as recited in claim 1 wherein the logic system directs the data message to the remote sub network if the logic system determines that the data message must be satisfied by the remote sub network.

3. A system as recited in claim 1 wherein the data message is a data query.

4. A system as recited in claim 1 wherein the data message is a data message.

5. A system as recited in claim 1 wherein the hub further contains a program application that is operatively communicative to at least one of the plurality of data processing systems.

6. A method for managing supply chain information including a plurality of sub networks, each one of which comprises a hub for containing common information and a plurality of data processing systems for issuing data messages to the hub, the method comprising:
(a) receiving a data message at the hub of a sub network; and
(b) determining whether the data message can be satisfied wholly within the sub network of which the one of the plurality of data processing systems is a member, or whether it must be satisfied within a remote sub network.

7. A method as recited in claim 6 further comprising:
(a) directing the data message to the storage system within the hub of the sub network of which the one of the plurality of data processing systems is a member if it is determined that the data message can be satisfied wholly within that sub network; and
(b) alternatively, directing the data message to a storage system within a hub of the remote network if it is determined that the data message must be satisfied within the remote sub network.

8. A method as recited in claim 7 wherein the hub further comprises a software application that is operatively communicative with each of the plurality of data processing systems within the native sub network.

9. A method as recited in claim 6 wherein the aggregating includes metadata caching of data from each of the plurality of data systems in the native sub network.

10. A method as recited in claim 6 further comprising translating the data from each of the plurality of data systems in the native sub network to a common data format.

11. A method as recited in claim 10 wherein the translating step is performed prior to the aggregating step.

12. A method as recited in claim 10 wherein the translating step is performed after the aggregating step.

13. A storage medium containing a computer program thereon which, when loaded and executed on a computer, causes the following functions for managing supply chain information including a plurality of sub networks, each one of which comprises a hub for containing common information and a plurality of data processing systems for issuing data messages to the hub to be performed:
(a) receiving a data message at the hub of a sub network; and
(b) determining whether the data message can be satisfied wholly within the sub network of which the one of the plurality of data processing systems is a member, or whether it must be satisfied within a remote sub network.

14. A storage medium as recited in claim 13 further comprising:
(a) directing the data message to the storage system within the hub of the sub network of which the one of the plurality of data processing systems is a member if it is determined that the data message can be satisfied wholly within that sub network; and
(b) alternatively, directing the data message to a storage system within a hub of the remote network if it is determined that the data message must be satisfied within the remote sub network.

15. A storage medium as recited in claim 14 wherein the hub further comprises a software application that is operatively communicative with each of the plurality of data processing systems within the native sub network.

16. A storage medium as recited in claim 13 wherein the aggregating includes metadata caching of data from each of the plurality of data systems in the native sub network.

17. A storage medium as recited in claim 13 further comprising translating the data from each of the plurality of data systems in the native sub network to a common data format.

18. A storage medium as recited in claim 17 wherein the translating step is performed prior to the aggregating step.

19. A storage medium as recited in claim 17 wherein the translating step is performed after the aggregating step.

20. A system for managing supply chain information comprising:
(a) a local sub network comprising:
(i) a hub for containing common information;
(ii) a plurality of data processing systems for issuing data messages to the hub;
(b) a communication system for communicating between the hub of the local sub network and a hub of a remote sub network; and
(c) a logic system in communication with the hub of the local sub network for determining whether a data message from one of the plurality of data processing systems can be satisfied wholly within the local sub network, or whether it must be satisfied within the remote sub network.

21. A system as recited in claim 20 wherein the logic system directs the data message to the hub of the remote sub network if the logic system determines that the data message must be satisfied by the remote sub network.

22. A system as recited in claim 20 wherein the logic system, upon determining that the data message can be satisfied wholly within the local sub network, performs the following steps:
(a) identifies which one of the plurality of data processing systems can satisfy the data message; and
(b) directs the data message to the identified data processing system.
